(19) United States
(12) Patent Application Publication
(10) Pub. No.: US 2007/0049493 A1
(43) Pub. Date: Mar. 1, 2007

(54) Planographic printing plate material

(75) Inventor: Takahiro Mori, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/502,204

(22) Filed: Aug. 10, 2006

(30) Foreign Application Priority Data
Aug. 30, 2005 (JP) JP2005-249022

(51) Int. Cl. B41M 5/20

(52) U.S. Cl. 503/226

(57) ABSTRACT

Disclosed is a printing plate material comprising a substrate and provided thereon, a component layer and a thermosensitive image formation layer, the component layer being provided between the substrate and the thermosensitive image formation layer, wherein the thermosensitive image formation layer contains a silicates and a carbonate, and at least one of the component layer and the thermosensitive image formation layer contains a light-to-heat conversion material.

This application is based on Japanese Patent Application No. 2005-249022, filed on Aug. 30, 2005 in Japanese Patent Office, the entire content of which is hereby incorporated by reference.

### FIELD OF THE INVENTION

The present invention relates to a printing plate material and a printing process, and particularly to a printing plate material capable of forming an image according to a computer to plate (CTP) system.

### BACKGROUND OF THE INVENTION

In recent years, printing employing a CTP system has been conducted in printing industries, accompanied with the digitization of printing data. A printing plate material for CTP, which is inexpensive, can be easily handled, and has a printing ability comparable with that of a PS plate, is required.

A versatile processless printing plate has been sought, which has a direct imaging (DI) property not requiring any development employing a specific developer, can be applied to a printing press with a direct imaging (DI) function, and can be handled in the same manner as in PS plates.

A thermal processless printing plate material is imagewise exposed employing an infrared laser with an emission wavelength of from near-infrared to infrared regions to form an image. The thermal processless printing plate material employing this method is divided into two types; an ablation type printing plate material and an on-press development type printing plate material with a heat melting image formation layer.

Examples of the ablation type printing plate material include those disclosed in for example, Japanese Patent O.P.I. Publication Nos. 8-507727, 6-186750, 6-199064, 7-314934, 10-58636 and 10-244773.

These references disclose a printing plate material comprising a support, and provided thereon, a hydrophilic layer and a lipophilic layer, either of which is an outermost layer. When a printing plate material is imagewise exposed in which the hydrophilic layer is an outermost layer, the hydrophilic layer is removed by ablation to reveal the lipophilic layer, whereby an image is formed. This printing plate material has problem that the exposure device used is contaminated by the ablated matter, and a special suction device is required for removing the scattered material. Therefore, this printing plate material is low in versatility to the exposure device.

There is a printing plate material, which is capable of forming an image without ablation, and does not require development treatment employing a special developer or wiping-off treatment. There is, for example, a printing plate material for CTP which comprises a thermosensitive image formation layer containing thermoplastic particles and a water-soluble binder and which is capable of being developed with a dampening solution or printing ink on a printing press (See for example, Japanese Patent O.P.I. Publication Nos. 9-123387 and 9-123388.). The thermosensitive image formation layer at exposed portions increases water resistance and mechanical strength layer by heat fusion of the thermoplastic particles and lowers solubility or dispersibility to dampening water. The thermosensitive image formation layer at exposed portions acts as image portions receiving printing ink without being removed by tackiness of printing ink during printing, while the thermosensitive image formation layer at unexposed portions is dissolved or dispersed in dampening water or is removed by tackiness of printing ink during printing to migrate to the printing ink.

The thermoplastic particles are plasticated by pressure, and thermoplastic particles in the image formation layer subjected to pressure such as scratching fuse with each other, and pushed into the convexoconcave surface of the substrate to fix to the surface, forming ink-receptive portions. This causes stain occurrence due to scratching. Therefore, such a printing plate material is required to handle with special care. Further, stain occurrence due to scratching requires re-plate-making, and lowers productivity.

Heat fusion of the thermoplastic particles in the image formation layer alone does not provide sufficient strength of image formation layer at image portions or sufficient adhesion strength between image formation layer at image portions and the substrate, resulting in insufficient printing durability or chemical resistance.

There is proposed a printing plate material with improved handling properties which comprises an overcoat containing water-soluble celluloses on an image formation layer containing hydrophobic particle precursors such as thermoplastic particles (see, for example, Japanese Patent O.P.I. Publication No. 2002-19318.). This printing plate material improves handling properties, however, it has problems in that ink-receptivity at image portions is poor at an initial printing stage, and on-press developability at unexposed portions is poor, resulting in increase of paper wastes. Further, the overcoat layer does not contribute to the strength of the image formation layer at the image portions, wherein printing durability is not improved.

As described above, it was difficult to improve all of printing durability, chemical resistance, and resistance to stain occurrence due to scratching (hereinafter referred to as scratch stain resistance) in conventional printing plate materials of on-press development type.

### SUMMARY OF THE INVENTION

An object of the invention is to provide a printing plate material providing high printing durability, excellent chemical resistance, and excellent scratch stain resistance.

### DETAILED DESCRIPTION OF THE INVENTION

The above object of the invention can be attained by the following constitutions.

1. A printing plate material-comprising a substrate and provided thereon, a component layer and a thermosensitive image formation layer, the component layer being provided between the substrate and the thermosensitive image formation layer, wherein the thermosensitive image formation layer contains a silicate and a carbonate, and at least one of the component layer and the thermosensitive image formation layer contains a light-to-heat conversion material.

2. The printing plate material of item 1 above, wherein the silicate is lithium silicate. 3. The printing plate material of item 1 above, wherein the thermosensitive image formation layer further contains particles with an average particle size of from 50 nm to 5 μm.

4. The printing plate material of item 3 above, wherein the particles are metal oxide particles or particles of a blocked isocyanate compound, which is a reaction product of an isocyanate compound, a polyol, and an isocyanate group-blocking agent.

5. The printing plate material of item 1 above, wherein the thermosensitive image formation layer contains a light-to-heat conversion material.

6. The printing plate material of item 1 above, wherein an oleophilic overcoat layer, containing heat curable resins or thermoplastic resins, is provided on the thermosensitive image formation layer.

7. The printing plate material of item 1 above, wherein the component layer is a hydrophilic layer comprising metal oxide particles.

8. The printing plate material of item 1 above, wherein the component layer is an oleophilic layer comprising an oleophilic organic polymer.

9. The printing plate material of item 1 above, wherein the thermosensitive image formation layer contains 10 to 80% by weight in terms of SiO₂ of the silicate and 5 to 50% by weight of the carbonate.

10. A printing plate material comprising a substrate, the surface of which is subjected to hydrophilization treatment to form a hydrophilic surface, and a thermosensitive image formation layer on the hydrophilic surface, wherein the thermosensitive image formation layer contains a silicate, a carbonate, and a light-to-heat conversion material.

11. The printing plate material of item 10 above, wherein the silicate is lithium silicate.

12. The printing plate material of item 10 above, wherein the thermosensitive image formation layer further contains particles with an average particle size of from 50 nm to 5 μm.

13. The printing plate material of item 12 above, wherein the particles are metal oxide particles or particles of a blocked isocyanate compound, which is a reaction product of an isocyanate compound, a polyol, and an isocyanate group-blocking agent.

14. The printing plate material of item 10 above, wherein an oleophilic overcoat layer, containing heat curable resins or thermoplastic resins, is provided on the thermosensitive image formation layer.

15. The printing plate material of item 10 above, wherein the thermosensitive image formation layer contains 10 to 80% by weight in terms of SiO₂ of the silicate and 5 to 50% by weight of the carbonate.

16. A process of manufacturing a printing plate, the process comprising the steps of imagewise exposing the printing plate material of item 1 or 10 above, and carrying out on-press development by supplying a dampening water to the exposed printing plate material on the plate cylinder of a press, whereby the image formation layer at unexposed portions is removed.

The present invention will be explained in detail below.

<Thermosensitive Image Formation Layer>

The thermosensitive image formation layer (hereinafter referred to simply as the image formation layer) in the printing plate material of the invention contains a silicate and a carbonate.

Examples of the silicate include an alkali metal silicate such as sodium silicate, potassium silicate or lithium silicate; ammonium silicate; and a salt of an organic base and silicic acid. Among these, lithium silicate is preferred.

Examples of the carbonate include ammonium carbonate and an organic amine carbonate such as guanidine carbonate or an amine carbonate. In the invention, a carbonate having high water solubility is preferably used. Herein, the carbonate having high water solubility is one dissolved in 25° C water in an amount of 5 g or more. Among these, guanidine carbonate is preferred.

It is known that a silicate-containing coat, when neutralized with carbonates, increases water resistance. Lithium silicate is used for a carbon dioxide-absorbing agent. Lithium silicate reacts rapidly with carbonates at around 100° C. to produce lithium carbonate, resulting in increase of water resistance.

An image formation layer, containing a silicate and a carbonate having high water solubility as a carbonic acid-providing agent, increases water solubility before heated, and increases water resistance at heated portions after heated, which provides high S/N during image formation.

The printing plate material of the invention has difference in water resistance between image formation layer at heated portions (exposed portions) and image formation layer at unheated portions (unexposed portions). The printing plate material of the invention is imagewise heated (exposed), and developed with an aqueous developer, whereby an image is formed. Alternatively, the imagewise heated (exposed) printing plate material is mounted on the plate cylinder of a press without development, and is subjected to on-press development by supplying a dampening solution or both a dampening solution and printing ink, while rotating the plate cylinder, whereby an image is formed.

For example, an image formation layer, which is comprised of a silicate, a carbonate and preferably hydrophilic particles described later, is cured at heated portions but has hydrophilicity. When a printing plate material having such an image formation layer on a substrate having an oleophilic surface is imagewise heated (exposed) and subjected to development with an aqueous developer or to on-press development, the image formation layer at unheated (unexposed) portions is removed to reveal the oleophilic surface of the substrate which is ink-receptive. Thus, a positive printing plate is obtained.

The content of the silicate in the image formation layer is preferably from 10 to 80% by weight, and more preferably from 20 to 70% by weight in terms of SiO₂. The content of the carbonate in the image formation layer is preferably from 5 to 50% by weight, and more preferably from 10 to 40% by weight.

(Particles)

The image formation layer in the invention preferably contains particles having an average particle size of from 50 nm to 5 μm. The shape of the particles may be spherical, polyhedral, planar, acicular, or irregular. The particles may be porous. In the invention, the particle size of the particles is defined as a diameter of a circle having the same area as a projected image of the particles, and the particle size can be determined from a projected area on an electron micrograph of the particles, taken at ×10000 to 50000 magnification. The average particle size of the particles is an average of the particle size of 100 particles selected arbitrarily. The average particle size of the particles can be measured through an image analyzer, LUZEX series available from NIRECO Corporation.

Addition of the particles improves developability of the image formation layer at unheated (unexposed) portions. The particles having an average particle size of not more than 5 μm increase developability, while the particles having an average particle size of not less than 50 nm increase resolution of images formed.

Hydrophilic particles can be used as the particles as described above. The hydrophilic particles act as a development accelerator at unheated (unexposed) portions and as a layer-enhancing agent at heated (exposed) portions.

Examples of the hydrophilic particles include inorganic particles such as particles of silica, alumina, aluminosilicate, titania, zirconia, etc.), organic particles such as particles of cellulose, calcium alginate, chitosan, etc.), and organic particles whose surface is coated with inorganic particles.

The image formation layer containing the particles can minimize stain resulting from scratches contributing to ink receptivity during printing.

As described above, the printing plate material having, on the oleophilic substrate, an image formation layer containing hydrophilic particles provides a positive printing plate. In a printing plate material having, on a substrate with a hydrophilic surface, an image formation layer containing hydrophilic particles and an oleophilic overcoat layer as described later, the image formation layer at heated (exposed) portions is ink-receptive. Thus, a negative printing plate is obtained.

Oleophilic particles can be used as the particles as described above. The Oleophilic particles act as a development accelerator at unheated (unexposed) portions and as a layer-enhancing agent and ink receptivity-increasing agent at heated (exposed) portions. In a printing plate material having, on a substrate with a hydrophilic surface, an image formation layer containing oleophilic particles, the image formation layer at heated (exposed) portions is ink-receptive. Thus, a negative printing plate is obtained. The printing plate further having an oleophilic overcoat layer can increase ink receptivity.

Examples of the oleophilic particles include thermoplastic resin particles (for example, heat melting wax particles or heat fusible polymer particles). As the oleophilic particles, resin particles having low thermoplasticity or heat resistance of not less than 150° C. are preferably used. Since the resin particles having low thermoplasticity have low plasticity to pressure, scratches contributing to ink receptivity are difficult to reach at the surface of the substrate, which minimizes stain occurrence.

Particles of a blocked isocyanate compound can be used as the particles as described above. The blocked isocyanate compound particles also act as a development accelerator at unheated (unexposed) portions and as a layer-enhancing agent and ink receptivity increasing agent at heated (exposed) portions. In a printing plate material having an image formation layer containing blocked isocyanate compound particles and a salt of an organic base and carbonic acid, cross-linking reaction occurs between the organic base and isocyanate regenerated by heat application, which provides an image formation layer at heated (exposed) portions having high water resistance and enhanced layer strength.

(Blocked Isocyanate Compound)

The blocked isocyanate compound in the invention is a reaction product of an isocyanate compound, a polyol and an isocyanate group-blocking material (hereinafter referred to simply as a blocking material).

(Blocking Material)

The blocking material in the invention is a compound which adds to an isocyanate group to produce a urethane bond or a urea bond. Examples thereof include an alcohol type blocking material such as methanol, or ethanol; a phenol type blocking material such as phenol or cresol; an oxime type blocking material such as formaldoxime, acetaldoxime, methyl ethyl ketoxime, methyl isobutyl ketoxime, cyclohexanone oxime, acetoxime, diacetyl monoxime, or benzophenone oxime; an acid amide type blocking material such as acetanilide, ε-caprolactam, or γ-butyrolactam; an active methylene containing blocking material such as dimethyl malonate or methyl acetoacetate; a mercaptan type blocking material such as butyl mercaptan; an imide type blocking material such as succinic imide or maleic imide; an imidazole type blocking material such as imidazole or 2-methylimidazole; a urea type blocking material such as urea or thiourea; an amine type blocking material such as diphenylamine or aniline; and an imine type blocking material such as ethylene imine or polyethylene imine. Among these, the oxime type blocking material is preferred.

It is preferred that the blocking material is employed in such an amount that the total amount of active hydrogen of the blocking material and the polyol is from 1.0 to 1.1 equivalent based on the isocyanate group of the isocyanate compound.

Temperature (dissociation temperature) at which the blocked isocyanate compound is dissociated to produce the free isocyanate group is preferably from 80 to 200° C., more preferably from 80 to 160° C., and still more preferably from 80 to 130° C.

(Isocyanate Compound)

The isocyanate compound in the invention is a compound having an isocyanate group in the molecule. Examples of the isocyanate compound include an aromatic polyisocyanate such as diphenylmethane diisocyanate (MDI), tolylene diisocyanate (TDI), polyphenylpolymethylene polyisocyanate (crude MDI), or naphthalene diisocyanate (NDI); an aliphatic polyisocyanate such as 1,6-hexamethylene diisocyanate (HDI), or lysine diisocyanate (LDI); an alicyclic polyisocyanate such as isophorone diisocyanate (IPDI), dicyclohexylmethane diisocyanate (hydrogenation MDI), or cyclohexylene diisocyanate; an aromatic aliphatic Polyisocyanate such as xylylene diisocyanate (XDI), or tetramethylxylene diisocyanate (TMXDI); and their modified compounds such as those having a burette group, an isocyanurate group, a carbodiimide group, or an oxazolidine group); and a urethane polymer having an isocyanate group in the molecular end, which is comprised of an active hydrogen-containing compound with a molecular weight of from 50 to 5,000 and the polyisocyanate described above. The polyisocyanates described in Japanese Patent O.P.I. Publication No. 10-72520 are preferably used.

Among those polyisocyanates, tolylene diisocyanate is especially preferred in view of high reactivity.

Addition of a polyol to a polyisocyanate can improve storage stability of the blocked isocyanate compound. When the image formation layer in the invention is imagewise heated, the resulting image increases image strength, resulting in improvement of printing durability.

Examples of the polyol include a polyhydric alcohol such as propylene glycol, triethylene glycol, glycerin, trimethylol methane, trimethylol propane, pentaerythritol, neopentyl glycol, 1,6-hexylene glycol, hexamethylene glycol, xylylene glycol, sorbitol or sucrose; polyether polyol which is prepared by polymerizing the polyhydric alcohol or a polyamine with ethylene oxide and/or propylene oxide; polytetramethylene ether polyol; polycarbonate polyol; polycaprolactone polyol; polyester polyol, which is obtained by reacting the above polyhydric alcohol with polybasic acid such as adipic acid, phthalic acid, isophthalic acid, terephthalic acid, sebatic acid, fumaric acid, maleic acid, or azelaic acid; polybutadiene polyol; acrylpolyol; a graft copolymer polyol prepared by graft polymerization of a vinyl monomer in the presence of polyether polyol or polyester polyol; and an epoxy modified polyol.

Among these, a polyol having a molecular weight of from 50 to 5,000 such as propylene glycol, triethylene glycol, glycerin, trimethylol methane, trimethylol propane, pentaerythritol, neopentyl glycol, 1,6-hexylene glycol, butane diol, hexamethylene glycol, xylylene glycol, or sorbitol is preferred, and a low molecular weight polyol having a molecular weight of from 50 to 500 is especially preferred.

Polyol is employed in such an amount that the total amount of the active hydrogen of the blocking material and the polyol is preferably from 1.0 to 1.1 equivalent based on the isocyanate group of the isocyanate compound. Further, the hydroxyl group of the polyol is preferably from 0.1 to 0.9 equivalent, and more preferably from 0.2 to 0.9 equivalent, based on the isocyanate group of the isocyanate compound, in providing improved storage stability of the blocked isocyanate compound.

As a blocking method of an isocyanate compound, there is, for example, a method comprising the steps of dropwise adding a blocking material to the isocyanate compound at 40 to 120° C. while stirring under an anhydrous condition and an inert gas atmosphere, and after addition, stirring the mixture solution for additional several hours. In this method, a solvent can be used, and a known catalyst such as an organometallic compound, a tertiary amine or a metal salt can be also used.

Examples of the organometallic compound include a tin catalyst such as stannous octoate, dibutyltin diacetate, or dibutyltin dilaurate; and a lead catalyst such as lead 2-ethylhexanoate. Examples of the tertiary amine include triethylamine, N,N-dimethylcyclohexylamine, triethylenediamine, N,N′-dimethylpiperazine, and diazabicyclo (2,2,2)-octane. Examples of the metal salt include cobalt naphthenate, calcium naphthenate, and lithium naphthenate. These catalysts are used in an amount of ordinarily from 0.001 to 2% by weight, and preferably from 0.01 to 1% by weight based on 100 parts by weight of isocyanate compound.

The blocked isocyanate compound is preferably dispersed in an image formation layer coating liquid, i.e., an aqueous image formation layer coating liquid is preferably an aqueous dispersion of the blocked isocyanate compound.

The blocked isocyanate compound in the invention, which is a reaction product of an isocyanate compound, a polyol, and a blocking material, is obtained by reacting the isocyanate compound with the polyol, and then reacting a residual isocyanate group with the blocking material or by reacting the isocyanate compound with the blocking material, and then reacting a residual isocyanate group with the polyol. The blocked isocyanate compound in the invention has an average molecular weight of preferably from 500 to 2,000, and more preferably from 600 to 1,000. This range of the molecular weight provides good reactivity and storage stability.

The blocked isocyanate compound obtained above is added to an aqueous solution containing a surfactant, and vigorously stirred in a homogenizer to obtain an aqueous dispersion of blocked isocyanate compound. Examples of the surfactant include an anionic surfactant such as sodium dodecylbenzene sulfonate, sodium lauryl sulfate, sodium dodecyldiphenylether disulfonate, or sodium dialkyl succinate sulfonate; a nonionic surfactant such as polyoxyethylenealkyl ester or polyoxyethylenealkyl aryl ester; and an amphoteric surfactant including an alkyl betaine such as lauryl bataines or stearyl betaine and an amino acid such as lauryl β-alanine, lauryldi(aminoethyl)glycine, or octyldi(aminoethyl)glycine. These surfactant may be used singly or in combination. Among these, the nonionic surfactant is preferred.

The solid content of the aqueous dispersion of the blocked isocyanate compound is preferably from 10 to 80% by weight. The surfactant content of the aqueous dispersion is preferably from 0.01 to 20% by weight based on the solid content of the aqueous dispersion.

When an organic solvent is used in a blocking reaction of the isocyanate compound, the organic solvent can be removed from the resulting aqueous dispersion.

The content of the particles in the image formation layer is preferably from 1 to 40% by weight, and more preferably from 2 to 20% by weight.

The coating amount of the image formation layer is preferably from 0.1 to 3 g/m², and more preferably from 0.2 to 1.5 g/m².

<Oleophilic Overcoat Layer>

The printing plate material of the invention can provide an oleophilic overcoat layer as an ink receptive layer. Materials usable for the oleophilic overcoat layer may be any materials, as long as ink receptivity of the oleophilic overcoat layer is obtained. For example, known heat curable resins or thermoplastic resins are used.

Examples of the heat curable resins include a urea resin, a melamine resin, a phenol resin, an epoxy resin, an unsaturated polyester resin, an alkyd resin and a urethane resin. Examples of thermoplastic resins include resins such as an ethylene copolymer, a polyamide resin, a polyester resin, a polyurethane resin, a polyolefin resin, an acryl resin, a vinyl chloride resin, a cellulose resin, a rosin resin, a polyvinyl alcohol resin, a polyvinyl acetal resin, an ionomer resin and a petroleum resin; elastomers such as natural rubber, styrene-butadiene rubber, isoprene rubber, chloroprene rubber and a diene polymer; rosin derivatives such as ester gum, a rosin-maleic acid resin, a rosin-phenol resin and a hydrogenated rosin; and polymeric compounds such as a phenol resin, a terpene resin, a cyclopentadiene resin and an aromatic hydrocarbon resin.

A coating liquid in which these materials are dissolved in an organic solvent can be used for an overcoat layer coating liquid. In the invention, an aqueous coating liquid is preferably used for the overcoat layer coating liquid. It is preferred that the overcoat layer is formed from an emulsion containing these materials. As the emulsion, an acryl resin emulsion or a urethane resin emulsion is especially preferred.

It is preferred that the oleophilic overcoat layer has high layer strength and is likely to be removed during on-press development. This means that the overcoat layer preferably has the property that it ruptures before stretched much. In order to provide such a property, the overcoat layer can provide brittleness by addition of cross-linking agents or inorganic materials.

The coating amount of the oleophilic overcoat layer is preferably from 0.01 to 3 g/m², and more preferably from 0.1 to 1 g/m².

<Component Layer>

In the invention, the component layer is a layer provided between the substrate and the image formation layer. Examples of the component layer include a hydrophilic layer and an oleophilic layer, each described later. A light-to-heat conversion material is contained in the component layer or the image formation layer, and preferably in the image formation layer. The light-to-heat conversion material content of the component layer or image formation layer is preferably from 1 to 40% by weight, and more preferably from 2 to 20% by weight, based on the solid content of the layer.

(Light-to-Heat Conversion Material)

A light-to-heat conversion material is contained in the component layer in the printing plate material of the invention. As the light-to-heat conversion material, there are an infrared absorbing dye (IR dye) or pigments.

Examples of the infrared absorbing dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination. Compounds described in Japanese Patent O.P.I. Publication Nos. 11-240270, 11-265062, 2000-309174, 2002-49147, 2001-162965, 2002-144750, and 2001-219667 can be preferably used.

Examples of the pigments include carbon black, graphite, metal particles and metal oxide particles. Furnace black and acetylene black is preferably used as the carbon black. The graininess (d₅₀) thereof is preferably not more than 100 nm, and more preferably not more than 50 nm.

The graphite is one having an average particle size of preferably not more than 0.5 μm, more preferably not more than 100 nm, and most preferably not more than 50 nm.

As the metal, any metal can be used as long as the metal is in a form of fine particles having preferably an average particle size of not more than 0.5 μm, more preferably not more than 100 nm, and most preferably not more than 50 nm. The metal may have any shape such as spherical, flaky and needle-like. Colloidal metal particles such as those of silver or gold are particularly preferred.

As the metal oxide, materials having black color in the visible regions or materials which are electro-conductive or semi-conductive can be used. Examples of the former include black iron oxide and black complex metal oxides containing at least two metals. Examples of the latter include Sb-doped SnO₂ (ATO), Sn-added In₂O₃ (ITO), TiO₂, TiO prepared by reducing TiO₂ (titanium oxide nitride, generally titanium black). Particles prepared by covering a core material such as BaSO₄, TiO₂, 9Al₂O₃.2B₂O and K₂O.nTiO₂ with these metal oxides is usable. These oxides are particles having an average particle size of not more than 0.5 μm, preferably not more than 100 nm, and more preferably not more than 50 nm.

Among these light-to-heat conversion materials, black iron oxide or black complex metal oxides containing at least two metals are more preferred.

The black iron oxide (Fe₃O₄) particles have an average particle size of from 0.01 to 1 μm, and an acicular ratio (major axis length/minor axis length) of preferably from 1 to 1.5. It is preferred that the black iron oxide particles are substantially spherical ones (having an acicular ratio of 1) or octahedral ones (having an acicular ratio of around 1.4). Examples of the black iron oxide particles include for example, TAROX series produced by Titan Kogyo K.K. Examples of the spherical particles include BL-100 (having an average particle size of from 0.2 to 0.6 μm), and BL-500 (having an average particle size of from 0.3 to 1.0 μn). Examples of the octahedral particles include ABL-203 (having an average particle size of from 0.4 to 0.5 μm), ABL-204 (having an average particle size of from 0.3 to 0.4 μm), ABL-205 (having an average particle size of from 0.2 to 0.3 μm), and ABL-207 (having an average particle size of 0.2 μm).

The black iron oxide particles may be surface-coated with inorganic compounds such as SiO₂. Examples of such black iron oxide particles include spherical particles BL-200 (having an average particle size of from 0.2 to 0.3 μm) and octahedral particles ABL-207A (having an average particle size of 0.2 μm), each having been surface-coated with SiO₂.

Examples of the black complex metal oxides containing at least two metals include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide is preferably a Cu—Cr—Mn type complex metal oxide or a Cu—Fe—Mn type complex metal oxide. The Cu—Cr—Mn type complex metal oxides are preferably subjected to the treatment disclosed in Japanese Patent O.P.I. Publication Nos. 8-27393 in order to reduce isolation of a 6-valent chromium ion. These complex metal oxides provide high light heat conversion efficiency relative to the addition amount thereof in the light sensitive layer.

The primary average particle size of these complex metal oxides is preferably from 0.001 to 1.0 μm, and more preferably from 0.01 to 0.5 μm. The primary average particle size of from 0.001 to 1.0 μm improves light heat conversion efficiency relative to the addition amount of the particles, and the primary average particle size of from 0.05 to 0.5 μm further improves light heat conversion efficiency relative to the addition amount of the particles. Light heat conversion efficiency to the addition amount of the particles is greatly influenced by degree of dispersion of the particles. The higher the degree of dispersion of the particles, the higher the light heat conversion efficiency.

Accordingly, these complex metal oxide particles are preferably dispersed according to a known method to prepare a dispersion (paste), which is added to a coating solution. When these complex metal oxide particles are dispersed, a dispersant can be used appropriately. The used amount of the dispersant is preferably from 0.01 to 5% by weight, and more preferably from 0.1 to 2% by weight, based on the weight of complex metal oxide particles.

<Substrate>

The substrate in the invention is a plate or film capable of carrying an image formation layer, and those well known in the art as substrates for printing plates can be used in the invention. Examples of the substrate include a metal plate, a plastic film sheet, a paper sheet treated with polyolefin, and composite sheets such as laminates thereof. The thickness of the substrate is not specifically limited as long as a printing plate employing the substrate can be mounted on a printing press, and is advantageously from 50 to 500 μm in easily handling.

Examples of the metal plate include iron, stainless steel, and aluminum. Aluminum is especially preferable in its gravity and stiffness. Aluminum is ordinarily used after degreased with an alkali, an acid or a solvent to remove oil on the surface, which has been used when rolled and wound around a spool. The degreasing is carried out preferably employing an aqueous alkali solution. In order to increase adhesion between the substrate and a coating layer, it is preferred that the surface of the substrate is subjected to adhesion increasing treatment or is coated with a subbing layer. For example, the substrate is immersed in a solution containing silicate or a coupling agent such as a silane coupling agent, or the substrate is coated with the solution and then sufficiently dried. Anodization treatment is considered to be one kind of adhesion increasing treatment, and can be used. The anodization treatment and the immersing or coating treatment described above can be used in combination. Aluminum plate (so-called grained aluminum plate), which has been surface-roughened with a conventional method, can be used as a substrate having a hydrophilic surface.

Examples of the plastic film include a polyethylene terephthalate film, a polyethylene naphthalate film, a polyimide film, a polyamide film, a polycarbonate film, a polysulfone film, a polyphenylene oxide film, and a cellulose ester film. The plastic film is preferably a polyethylene terephthalate film or a polyethylene naphthalate film. In order to increase adhesion between the substrate and a coating layer, it is preferred that the surface of the plastic film is subjected to adhesion increasing treatment or is coated with a subbing layer. Examples of the adhesion increasing treatment include corona discharge treatment, flame treatment, plasma treatment and UV light irradiation treatment. Examples of the subbing layer include a layer containing gelatin or latex. The subbing layer can contain a known organic or inorganic electrically conductive material.

A substrate with a known backcoat layer coated can be used in order to control slippage of the rear surface of the substrate (for example, in order to reduce friction between the rear surface and a plate cylinder of a printing press).

<Substrate with Hydrophilic Surface>

The substrate with hydrophilic surface is a substrate having a hydrophilic layer, and the substrate is preferably an aluminum plate, ordinarily an aluminum plate which has been surface roughened.

It is preferable that the aluminum plate is subjected to degreasing treatment for removing rolling oil prior to surface roughening (graining). The degreasing treatments include degreasing treatment, which employs solvents such as trichlene and thinner, and an emulsion degreasing treatment, which employs an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting substrate is preferably subjected to desmut treatment in an aqueous solution of an acid such as phosphoric acid, nitric acid, sulfuric acid, chromic acid, or a mixture thereof, since smut is produced on the surface of the substrate. The surface roughening methods include a mechanical surface roughening method and an electrolytic surface roughening method electrolytically etching the substrate surface.

Though there is no restriction for the mechanical surface roughening method, a brushing roughening method and a honing roughening method are preferable. Though there is no restriction for the electrolytic surface roughening method, a method, in which the substrate is electrolytically surface roughened in an acidic electrolytic solution, is preferred.

After the substrate has been electrolytically surface roughened, it is preferably dipped in an acid or an aqueous alkali solution in order to remove aluminum dust, etc. produced in the surface of the substrate. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The dissolution amount of aluminum in the substrate surface is preferably 0.5 to 5 g/m². After the substrate has been dipped in the aqueous alkali solution, it is preferable for the substrate to be dipped in an acid such as phosphoric acid, nitric acid, sulfuric acid and chromic acid, or in a mixed acid thereof, for neutralization.

The mechanical surface roughening and electrolytic surface roughening may be carried out singly, and the mechanical surface roughening followed by the electrolytic surface roughening may be carried out.

After the surface roughening, anodizing treatment may be carried out. There is no restriction in particular for the method of anodizing treatment used in the invention, and known methods can be used. The anodizing treatment forms an anodization film on the surface of the substrate.

The substrate which has been subjected to anodizing treatment is optionally subjected to sealing treatment. For the sealing treatment, it is possible to use known methods using hot water, boiling water, steam, a sodium silicate solution, an aqueous dichromate solution, a nitrite solution and an ammonium acetate solution.

After the above treatment, the substrate is suitably undercoated with a water soluble resin such as polyvinyl phosphonic acid, a polymer or copolymer having a sulfonic acid in the side chain, or polyacrylic acid; a water soluble metal salt such as zinc borate; a yellow dye; an amine salt; and so on, for hydrophilization treatment. The sol-gel treated substrate as disclosed in Japanese Patent O.P.I. Publication No. 5-304358, which has a functional group capable of causing addition reaction by radicals as a covalent bond, is suitably used.

<Hydrophilic Layer>

The hydrophilic layer in the invention is a layer capable of forming a non-image portion repelling printing ink during printing. The hydrophilic layer in the invention means one provided on the substrate or a hydrophilic surface of the substrate whose surface is subjected to hydrophilization treatment. The hydrophilic layer contains a hydrophilic material.

As the printing plate material in the invention, there is a printing plate material comprising a support having a hydrophilic layer. The hydrophilic layer may be a single layer or plural layers. The coating amount of the hydrophilic layer is preferably from 0.1 to 10 g/m², and more preferably from 0.2 to 5 g/m². Material used in the hydrophilic layer is preferably a water-insoluble hydrophilic material, and especially preferably a metal oxide.

The metal oxide is preferably metal oxide particles. Examples of the metal oxide particles include colloidal silica particles, an alumina sol, a titania sol and another metal oxide sol. The metal oxide particles may have any shape such as spherical, needle-like, and feather-like shape. The average particle size is preferably from 3 to 100 nm, and plural kinds of metal oxide each having a different size may be used in combination. The surface of the particles may be subjected to surface treatment.

The metal oxide particles can be used as a binder, utilizing its layer forming ability. The metal oxide particles are suitably used in a hydrophilic layer since they minimize lowering of the hydrophilicity of the layer as compared with an organic compound binder. Among the above-mentioned, colloidal silica is particularly preferred. The colloidal silica has a high layer forming ability under a drying condition with a relative low temperature, and can provide a high layer strength. It is preferred that the colloidal silica is necklace-shaped colloidal silica or colloidal silica particles having an average particle size of not more than 20 nm. Further, it is preferred that the colloidal silica provides an alkaline colloidal silica solution as a colloid solution.

The necklace-shaped colloidal silica is a generic term of an aqueous dispersion system of spherical silica having a primary particle size of the order of nm. The necklace-shaped colloidal silica to be used in the invention means a “pearl necklace-shaped” colloidal silica formed by connecting spherical colloidal silica particles each having a primary particle size of from 10 to 50 μm so as to attain a length of from 50 to 400 nm. The term of “pearl necklace-shaped” means that the image of connected colloidal silica particles is like to the shape of a pearl necklace. The bonding between the silica particles forming the necklace-shaped colloidal silica is considered to be —Si—O—Si—, which is formed by dehydration of —SiOH groups located on the surface of the silica particles. Concrete examples of the necklace-shaped colloidal silica include Snowtex-PS series produced by Nissan Kagaku Kogyo, Co., Ltd.

As the products, there are Snowtex-PS-S (the average particle size in the connected state is approximately 110 nm), Snowtex-PS-M (the average particle size in the connected state is approximately 120 nm) and Snowtex-PS-L (the average particle size in the connected state is approximately 170 nm). Acidic colloidal silicas corresponding to each of the above-mentioned are Snowtex-PS-S-O, Snowtex-PS-M-O and Snowtex-PS-L-O, respectively.

The necklace-shaped colloidal silica is preferably used in a hydrophilic layer as a porosity providing material for hydrophilic matrix phase, and porosity and strength of the layer can be secured by its addition to the layer. Among them, the use of Snowtex-PS-S, Snowtex-PS-M or Snowtex-PS-L, each being alkaline colloidal silica particles, is particularly preferable since the strength of the hydrophilic layer is increased and occurrence of background contamination is inhibited even when a lot of prints are printed.

It is known that the binding force of the colloidal silica particles is become larger with decrease of the particle size. The average particle size of the colloidal silica particles to be used in the invention is preferably not more than 20 nm, and more preferably 3 to 15 nm. As above-mentioned, the alkaline colloidal silica particles show the effect of inhibiting occurrence of the background contamination. Accordingly, the use of the alkaline colloidal silica particles is particularly preferable.

Examples of the alkaline colloidal silica particles having the average particle size within the foregoing range include Snowtex-20 (average particle size: 10 to 20 nm), Snowtex-30 (average particle size: 10 to 20 nm), Snowtex-40 (average particle size: 10 to 20 nm), Snowtex-N (average particle size: 10 to 20 nm), Snowtex-S (average particle size: 8 to 11 nm) and Snowtex-XS (average particle size: 4 to 6 nm), each produced by Nissan Kagaku Co., Ltd.

The colloidal silica particles having an average particle size of not more than 20 nm, when used together with the necklace-shaped colloidal silica as described above, is particularly preferred, since appropriate porosity of the layer is maintained and the layer strength is further increased. The ratio of the colloidal silica particles having an average particle size of not more than 20 nm to the necklace-shaped colloidal silica is preferably from 95/5 to 5/95, more preferably from 70/30 to 20/80, and most preferably from 60/40 to 30/70.

The hydrophilic layer in the invention preferably contains porous metal oxide particles as metal oxides. Examples of the porous metal oxide particles include porous silica particles, porous aluminosilicate particles or zeolite particles.

The porous silica particles are ordinarily produced by a wet method or a dry method. By the wet method, the porous silica particles can be obtained by drying and pulverizing a gel prepared by neutralizing an aqueous silicate solution, or pulverizing the precipitate formed by neutralization. By the dry method, the porous silica particles are prepared by combustion of silicon tetrachloride together with hydrogen and oxygen to precipitate silica. The porosity and the particle size of such particles can be controlled by variation of the production conditions. The porous silica particles prepared from the gel by the wet method is particularly preferred.

The porous aluminosilicate particles can be prepared by the method described in, for example, JP O.P.I. No. 10-71764. Thus prepared aluminosilicate particles are amorphous complex particles synthesized by hydrolysis of aluminum alkoxide and silicon alkoxide as the major components. The particles can be synthesized so that the ratio of alumina to silica in the particles is within the range of from 1:4 to 4:1. Complex particles composed of three or more components prepared by an addition of another metal alkoxide may also be used in the invention. In such a particle, the porosity and the particle size can be controlled by adjustment of the production conditions.

The porosity of the particles is preferably not less than 1.0 ml/g, more preferably not less than 1.2 ml/g, and most preferably of from 1.8 to 2.5 ml/g, in terms of pore volume before the dispersion.

The average particle size of the particles dispersed in the hydrophilic layer (or in the dispersed state before formed as a layer) is preferably not more than 1 μm, and more preferably not more than 0.5 μm.

The size of the porous inorganic particles in the hydrophilic layer is preferably not more than 1 μm, and more preferably not more than 0.5 μm.

The hydrophilic layer of the printing plate material in the invention can contain layer structural clay mineral particles as a metal oxide. Examples of the layer structural clay mineral particles include a clay mineral such as kaolinite, halloysite, talk, smectite such as montmorillonite, beidellite, hectorite and saponite, vermiculite, mica and chlorite; hydrotalcite; and a layer structural polysilicate such as kanemite, makatite, ilerite, magadiite and kenyte. Among them, ones having a higher electric charge density of the unit layer are higher in the polarity and in the hydrophilicity. Preferable charge density is not less than 0.25, more preferably not less than 0.6. Examples of the layer structural mineral particles having such a charge density include smectite having a negative charge density of from 0.25 to 0.6 and bermiculite having a negative charge density of from 0.6 to 0.9. Synthesized fluorinated mica is preferable since one having a stable quality such as stable particle size, is available. Among the synthesized fluorinated mica, swellable one is preferable and one freely swellable is more preferable.

An intercalation compound of the foregoing layer structural mineral particles such as a pillared crystal, or one treated by an ion exchange treatment or a surface treatment such as a silane coupling treatment or a complication treatment with an organic binder is also usable.

The planar structural mineral particles are preferably in the plate form, and have an average particle size (an average of the largest particle length) of preferably not more than 20 μm, and an average aspect ratio (the largest particle length/the particle thickness) of preferably not less than 20, and more preferably not less than 50, in a state contained in the layer including the case that the particles are subjected to a swelling process and a dispersing layer-separation process. The particles more preferably have an average particle size of preferably not more than 5 μm, and an average aspect ratio of not less than 50, and still more preferably have an average particle size of preferably not more than 1 μm, and an average aspect ratio of not less than 50. When the average particle size is within the foregoing range, continuity to the parallel direction, which is a trait of the layer structural particle, and softness, are given to the coated layer so that a strong dry layer in which a crack is difficult to be formed can be obtained. The coating solution containing the layer structural clay mineral particles in a large amount can minimize particle sedimentation due to a viscosity increasing effect.

The content of the layer structural clay mineral particles is preferably from 0.1 to 30% by weight, and more preferably from 1 to 10% by weight based on the total weight of the layer. Particularly, the addition of the swellable synthesized fluorinated mica or smectite is effective if the adding amount is small. The layer structural clay mineral particles may be added in the form of powder to a coating liquid, but it is preferred that gel of the particles which is obtained by being swelled in water, is added to the coating liquid in order to obtain a good dispersity according to an easy coating liquid preparation method which requires no dispersion process comprising dispersion due to media.

An aqueous solution of a silicate is also usable as another additive to the hydrophilic matrix phase in the invention. An alkali metal silicate such as sodium silicate, potassium silicate or lithium silicate is preferable, and the SiO₂/M₂O is preferably selected so that the pH value of the coating liquid after addition of the silicate exceeds 13 in order to prevent dissolution of the porous metal oxide particles or the colloidal silica particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybridpolymer by the sol-gel method.

In the invention, the hydrophilic layer can contain a hydrophilic organic resin. Examples of the hydrophilic organic resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, and polyvinyl pyrrolidone.

A cationic resin may also be contained in the hydrophilic layer. Examples of the cationic resin include a polyalkylene-polyamine such as a polyethyleneamine or polypropylenepolyamine or its derivative, an acryl resin having a tertiary amino group or a quaternary ammonium group and diacrylamine. The cationic resin may be added in a form of fine particles. Examples of such particles include the cationic microgel described in Japanese Patent O.P.I. Publication No. 6-161101.

In the invention, it is preferred that the hydrophilic organic resin contained in the hydrophilic layer is a water soluble resin, and at least a part of the resin exists in the hydrophilic layer in a state capable of being dissolved in water.

The water-soluble resin contained in the hydrophilic layer is preferably a saccharide.

As the saccharides, oligosaccharide detailed later can be used, but polysaccharides are preferably used.

As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable. These polysaccharides can form a preferred surface shape of the hydrophilic layer.

The hydrophilic layer may contain a light-to-heat conversion material such as infrared absorbing dye. Examples of the infrared absorbing dye include an organic compound such as a cyanine dye, a chloconium dye, a polymethine dye, an azulenium dye, a squalenium dye, a thiopyrylium dye, a naphthoquinone dye or an anthraquinone dye; and an organometallic complex of the phthalocyanine, naphthalocyanine, azo, thioamide, dithiol or indoaniline type.

The surface of the hydrophilic layer preferably has a convexoconcave structure having a pitch of from 0.1 to 50 μm such as the grained aluminum surface of an aluminum PS plate. The water retention ability and the image maintaining ability are raised by such a convexoconcave structure of the surface. Such a convexoconcave structure can also be formed by adding in an appropriate amount a filler having a suitable particle size to the coating liquid of the hydrophilic layer. However, the convexoconcave structure is preferably formed by coating a coating liquid for the hydrophilic layer containing the alkaline colloidal silica and the water-soluble polysaccharide so that the phase separation occurs at the time of drying the coated liquid, whereby a structure is obtained which provides a good printing performance.

The shape of the convexoconcave structure such as the pitch and the surface roughness thereof can be suitably controlled by the kinds and the adding amount of the alkaline colloidal silica particles, the kinds and the adding amount of the water-soluble polysaccharide, the kinds and the adding amount of another additive, a solid concentration of the coating liquid, a wet layer thickness or a drying condition.

The pitch in the convexoconcave structure is preferably from 0.2 to 30 μm, and more preferably from 0.5 to 20 μm. A multi-layered convexoconcave structure may be formed in which a convexoconcave structure with a smaller pitch is formed on one with a larger pitch.

The hydrophilic layer has a surface roughness Ra of preferably from 100 to 1000 nm, and more preferably from 150 to 600 nm.

A water-soluble surfactant may be added for improving the coating ability of the coating liquid for the hydrophilic layer in the invention. A silicon atom-containing surfactant and a fluorine atom-containing surfactant are preferably used. The silicon atom-containing surfactant is especially preferred in that it minimizes printing contamination. The content of the surfactant is preferably from 0.01 to 3% by weight, and more preferably from 0.03 to 1% by weight based on the total weight of the hydrophilic layer (or the solid content of the coating liquid).

The hydrophilic layer in the invention can contain a phosphate. Since a coating liquid for the hydrophilic layer is preferably alkaline, the phosphate to be added to the hydrophilic layer is preferably sodium phosphate or sodium monohydrogenphosphate. The addition of the phosphate provides improved reproduction of dots at shadow portions. The content of the phosphate is preferably from 0.1 to 5% by weight, and more preferably from 0.5 to 2% by weight in terms of amount excluding hydrated water.

<Substrate with Oleophilic Surface>

In the invention, a substrate with an oleophilic surface can be used. Examples thereof include a general resin substrate, a resin substrate with a subbing layer, a resin substrate with an oleophilic layer, and an aluminum substrate with an oleophilic layer. A substrate with an oleophilic layer is preferred, and the oleophilic layer is formed from a solvent soluble and film-forming oleophilic organic polymer, which is used in the oleophilic ink receptive layer of the thermosensitive planographic printing plate precursor as disclosed in Japanese Patent O.P.I. Publication No. 2002-86946. Examples of the oleophilic organic polymer include polyester, polyurethane, polyurea, polyimide, polysiloxane, polycarbonate, phenoxy resin, epoxy resin, phenol-formaldehyde resin, alkylphenol-formaldehyde resin, polyvinyl acetate, acryl polymer or copolymer, acrylamide copolymer, methacrylamide copolymer, polyvinyl formal, polyamide, polyvinyl butyral, polystyrene, cellulose ester resin, polyvinyl chloride and polyvinylidene chloride. A substrate with an oleophilic layer is preferably used, in which the oleophilic layer is formed from a copolymer with a molecular weight of from 10,000 to 200,000 having, as the constituent, any of monomers (1) through (12) described in paragraphs [0022] through [0026] of the patent document above. The coating amount of the oleophilic layer is preferably from 0.1 to 10 g/m², and more preferably from 0.2 to 5 g/m².

<On-Press Development>

Next, on-press development will be explained.

On-press development, i.e., removal on a press of image formation layer at unexposed portions of a printing plate material, which is mounted on the plate cylinder, can be carried out by bringing a dampening roller and an inking roller into contact with the image formation layer while rotating the plate cylinder. On-press development can be carried out, for example by various sequences as described below or another appropriate sequence without any limitations. The supplied amount of dampening solution may be adjusted to be greater or smaller than the amount ordinarily supplied in printing, and the adjustment may be carried out stepwise or continuously.

Sequence (1) A dampening roller is brought into contact with the image formation layer of a printing plate material on the plate cylinder during one to several tens of rotations of the plate cylinder, and then an inking roller brought into contact with the image formation layer during the next one to tens of rotations of the plate cylinder. Thereafter, printing is carried out.

Sequence (2) An inking roller is brought into contact with the image formation layer of a printing plate material on the plate cylinder during one to several tens of rotations of the plate cylinder, and then a dampening roller brought into contact with the image formation layer during the next one to tens of rotations of the plate cylinder. Thereafter, printing is carried out.

Sequence (3) An inking roller and a dampening roller are brought into contact with the image formation layer of a printing plate material on the plate cylinder during one to several tens of rotations of the plate cylinder. Thereafter, printing is carried out.

Generally, on-press development is carried out employing sequence (1) above. This is because a method, in which image formation layer at non-image portions is allowed to swell with water and removed by employing tackiness of printing ink of an ink roller, enables more efficient and rapid on-press development.

### EXAMPLES

The present invention will be explained below employing the following examples. In the examples, “parts” and “%” are parts by weight and % by weight, respectively, unless otherwise specified.

<Preparation of Substrate>

Substrate 1 (Substrate with a Hydrophilic Surface)

A 0.24 mm thick aluminum plate (material 1050, refining H16) was immersed in an aqueous 1% by weight sodium hydroxide solution at 50° C. to give an aluminum dissolution amount of 2 g/m², washed with water, immersed in an aqueous 5% by weight nitric acid solution at 25° C. for 30 seconds to neutralize, and then washed with water.

Subsequently, the aluminum plate was subjected to an electrolytic surface-roughening treatment in an electrolytic solution containing 11 g/liter of hydrochloric acid and 1.5 g/liter of aluminum at a peak current density of 80 A/dm² employing an alternating current with a sine waveform, in which the distance between the plate surface and the electrode was 10 mm. The electrolytic surface-roughening treatment was divided into 4 treatments, in which the quantity of electricity used in one treatment (at a positive polarity) was 50 C/dm², and the total quantity of electricity used (at a positive polarity) was 200 C/dm². Standby time of 4 seconds, during which no surface-roughening treatment was carried out, was provided after each of the separate electrolytic surface-roughening treatments.

Subsequently, the resulting aluminum plate was immersed in an aqueous 10% by weight phosphoric acid solution at 50° C. and etched to give an aluminum etching amount (including smut produced on the surface) of 0.6 g/m², and washed with water. Subsequently, the aluminum plate was subjected to anodizing treatment in an aqueous 20% by weight sulfuric acid solution at a current density of 4 A/dm² to form an anodization film having a coating amount of 2.5 g/m², and washed with water. The washed surface of the plate was squeegeed, and the plate was immersed in an aqueous 0.1% by weight sodium dihydrogenphosphate solution at 70° C. for 10 seconds, washed with water, and dried at 80° C. for 5 minutes. Thus, Substrate 1 was obtained.

The surface roughness Ra of Substrate 1 was 0.27 μm, measured according to the following method.

(Measurement of Surface Roughness)

A platinum-rhodium layer with a thickness of 1.5 nm are vacuum-deposited onto a sample surface, and surface roughness is measured under condition of a magnification of 20, employing a non-contact three dimensional surface roughness measuring device RST plus produced by WYKO Co., Ltd., (in which the measurement area is 222.4 μm×299.4 μm). The resulting measurement is subjected to slope correction and to filtering treatment of Median Smoothing. Five portions of each sample are measured and the average of the measurements is defined as surface roughness Ra of the sample.

Substrate 2 (Substrate with an Oleophilic Surface)

A 0.24 mm thick aluminum plate (material 1050, refining H16) was immersed in an aqueous 1% by weight sodium hydroxide solution at 50° C. to give an aluminum dissolution amount of 2 g/m², washed with water, immersed in an aqueous 5% by weight nitric acid solution at 25° C. for 30 seconds to neutralize, washed with water, and then dried at 100° C. for 3 minutes.

The oleophilic layer coating liquid described later was coated on the resulting aluminum plate through a wire bar, and dried 200° C. for 30 seconds to form an oleophilic layer having a dry thickness of 1.5 g/m². The thus obtained plate was further subjected to aging at 55° C. for 48 hours. Thus, substrate 2, an aluminum plate with an oleophilic layer, was obtained.

Substrate 3 (Substrate with a Hydrophilic Surface)

The hydrophilic layer coating liquid described later was coated on the oleophilic layer of the Substrate 2 obtained above through a wire bar, and dried 200° C. for 30 seconds to form a hydrophilic layer having a dry thickness of 3.0 g/m². The thus obtained plate was further subjected to aging at 55° C. for 48 hours. Thus, substrate 3, an aluminum plate with a hydrophilic layer on the oleophilic layer, was obtained.

<Preparation of Oleophilic Layer Coating Liquid>

The following oleophilic layer coating liquid composition was sufficiently mixed while stirring, and filtered to obtain an oleophilic layer coating liquid with a solid content of 20%.

(Oleophilic layer coating liquid composition)

| | |
|---|---|
| Colloidal silica (alkali type) Snowtex XS | 50.00 parts |
| (solid content: 20%, produced by Nissan Kagaku Co., Ltd.) | |
| Acryl emulsion AE986A | 15.31 parts |
| (Tg: 2° C., solid content: 35%, produced by JSR Co., Ltd.) | |
| Aqueous carbon black dispersion SD9020 | 6.67 parts |
| (true specific gravity: 2.0 g/cm³, an average primary | |
| particle size: not more than 100 nm, solid content: 30%, | |
| produced by Dainippon Ink Co., Ltd.) | |
| Porous metal oxide particles Silton JC 20 | 2.00 parts |
| (porous aluminosilicate particles having an average particle | |
| size of 2 μm, produced by Mizusawa Kagaku Co., Ltd.) | |
| Glycerol polyglycidyl ether | 0.60 parts |
| Aqueous 1% solution of | 4.00 parts |
| silicon-containing surfactant FZ2161 | |
| (Nippon Unicar Co., Ltd.) | |
| Pure water | 21.42 parts |

<Preparation of Hydrophilic Layer Coating Liquid>

The following hydrophilic layer coating liquid composition except for silicon-containing surfactant FZ2161 was sufficiently mixed while stirring at a rotation frequency of 10,000 for 10 minutes, employing a homogenizer. The resulting mixture was added with the silicon-containing surfactant FZ2161, weakly stirred, and filtered to obtain a hydrophilic layer coating liquid with a solid content of 30%.

(Hydrophilic layer coating liquid composition)

| | |
|---|---|
| Colloidal silica (alkali type) Snowtex XS | 78.75 parts |
| (average particle size: 5 nm, solid content: 20%, | |
| produced by Nissan Kagaku Co., Ltd.) | |
| Black iron oxide particles ABL-207 | 14.10 parts |
| (produced by Titan Kogyo K.K., octahedral form, true | |
| specific | |
| gravity: 5.0 g/cm³, average particle size: 0.2 μm, specific | |
| surface area: 6.7 m²/g, Hc: 9.95 kA/m, σs: 85.7 Am²/kg, | |
| σr/σs: 0.112) | |
| Aqueous 10% sodium phosphate.dodecahydrate | 1.20 parts |
| solution (Reagent produced by Kanto Kagaku Co., Ltd.) | |
| Aqueous 1% solution of | 3.00 parts |
| silicon-containing surfactant FZ2161 | |
| (Nippon Unicar Co., Ltd.) | |
| Pure water | 2.95 parts |

Pure water 2.95 parts

### Example 1

> Preparation of Image Formation Layer Coating Liquid>

The following image formation layer coating liquid composition as shown in Table 1 was sufficiently mixed while stirring, and filtered to obtain an image formation layer coating liquid having a solid content of 5%. Thus, image formation layer coating liquid Nos. (1) through (5) were obtained.

TABLE 1
(Image formation layer coating liquid composition)

| | Image formation layer coating | | | | |
|---|---|---|---|---|---|
| | liquid Nos. | | | | |
| Materials | (1) | (2) | (3) | (4) | (5) |
| Aqueous lithium silicate | *12.27 | 8.18 | 18.41 | 12.27 | None |
| solution (SiO2 content: | | | | | |
| 20%, SiO₂/Li₂O (by | | | | | |
| mole) = 4.5, produced by | | | | | |
| Nissan Kagaku Co., Ltd.) | | | | | |
| Guanidine carbonate | 1.50 | 1.00 | None | None | None |
| Aqueous acicular crystalline | None | 15.00 | None | 15.00 | None |
| cellulose slurry Ceolus | | | | | |
| Cream FP-03 (average | | | | | |
| particle size: 3 μm, solid | | | | | |
| content: 10%, manufactuted | | | | | |
| by Asahi Kasei Chemicals | | | | | |
| Co., Ltd.) | | | | | |
| Aqueous styrene-acryl | None | None | None | None | 9.38 |
| polymer particle dispersion | | | | | |
| (Average particle size: 100 | | | | | |
| nm, Tg: 85° C., solid | | | | | |
| content: 40%) | | | | | |
| Aqueous polyacrylic acid | None | None | None | None | 2.50 |
| solution (molecular weight: | | | | | |
| 170,000, solid content: | | | | | |
| 30%) | | | | | |
| 1% Aqueous solution of | 50.00 | 50.00 | 50.00 | 50.00 | 50.00 |
| Light-to-heat conversion | | | | | |
| material: Water soluble | | | | | |
| infrared absorbing dye (IR-1) | | | | | |
| Pure water | 36.23 | 25.82 | 31.59 | 22.73 | 38.12 |

*In Table 1, numerical values are parts by weight.

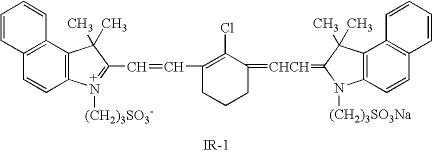

(Preparation of Printing Plate Material Samples)

Each of the image formation layer coating liquids (1) through (4) was coated on the oleophilic layer of Substrate 2, employing a wire bar and dried at 55° C. for 3 minutes to give an image formation layer with a dry thickness of 0.8 g/m². Thus, positive working printing plate material samples 1 through 4 were obtained.

Image formation layer coating liquid (5) was coated on the hydrophilic layer of Substrate 3, employing a wire bar and dried at 55° C. for 3 minutes to give an image formation layer with a dry thickness of 0.8 g/m². Thus, negative working printing plate material sample 5 was obtained.

(Aging of Printing Plate Material Samples)

Each of the printing plate material samples obtained above was divided into two kinds of samples, one was stored at 20° c for 24 hours (without aging), and the other was aged at 60° C. for 24 hours.

<Image Formation Employing Infrared Laser>

Each sample was mounted on an exposure drum, and imagewise exposed. The exposure was carried out employing an infrared laser (having a wavelength of 830 nm and a beam spot size of 18 μm) at a resolution of 2400 dpi (“dpi” herein shows the number of dots per 2.54 cm) and at a screen line number of 75 to form an image. The image pattern used for exposure had a solid image, and a dot image with a dot area of 1 to 99%. Exposure energy was 300 mJ/cm². Imagewise exposure for the negative working printing plate material sample was reversed to imagewise exposure for the positive working printing plate material sample.

(On-Press Development and Printing)

The exposed sample was mounted on a plate cylinder of a printing press, and printing was carried out in the same printing condition and printing sequence as a conventional PS plate to obtain 500 prints. Herein, printing was carried out employing a printing press, DAIYA 1F-1 produced by Mitsubishi Jukogyo Co., Ltd., and employing coated paper, a dampening solution, a 2% by weight solution of Astromark 3 (produced by Nikken Kagaku Kenkyusyo Co., Ltd.), and printing ink (Toyo King Hyecho M Magenta, produced by Toyo Ink Manufacturing Co.). Subsequently, printing was carried out in the same manner as above until additional 10,000 prints were obtained, except that fine-quality paper (Shiorai) was used instead of coated paper.

(Evaluation)

The following evaluation was carried out regarding the prints obtained above.

(Initial Printability)

The number of prints printed from the beginning of printing until a print with good image was obtained was determined. Herein, good image means an image in which stains are not found at the non-image portions and density of the solid image is not less than 1.5. A sample providing the 500^{th} print with a solid image density of less than 1.5 was evaluated as poor ink-receptive, a sample providing the 500^{th} print with no image formed as image formation failure, and a sample providing the 500^{th} print having stains at non-image portions as stain fault.

(Evaluation of Scratch Stain Resistance 1)

Scratches were marked at portions corresponding to non-image area of the exposed sample, employing a scratch tester produced by HEIDON CO., LTD. In the scratch marking, a sapphire needle with 0.3 mmφ was employed as a probe, and a weight from 50 to 300 g was loaded while the weight was changed at an interval of 25 g. Then, printing was carried out employing the sample with the scratches. Scratch stain was visually observed at the 50^{th} print, and the largest weight at which scratch stain was not observed was determined as a measure of scratch stain resistance 1. When scratch stain was not discriminated from ordinary stains, it was evaluated as indiscriminative. The larger the largest weight is, the higher the scratch stain resistance 1.

(Evaluation of Scratch Stain Resistance 2)

Scratches were marked by nails at portions corresponding to non-image area of the resulting exposed sample. Then, printing was carried out employing the sample with the scratches. Scratch stain was visually observed at the 50^{th} print, and evaluated according to the following three criteria. When scratch stain was not discriminated from ordinary stains, it was evaluated as indiscriminative.

A: No scratch stain was observed.

B: Slight scratch stain was observed.

C: Apparent scratch stain was observed.

<<Printing Durability>>

A solid image and non-image portions were visually observed whenever 1,000 prints were obtained. The number of prints, in which uneven image density was visually observed in the solid image or stain was visually observed at non-image portions, was determined as a measure of printing durability.

The results are collectively shown in Table 2.

TABLE 2

| | Image | | | | | |
|---|---|---|---|---|---|---|
| Printing | formation | | | | | |
| plate | layer | | | | | |
| material | coating | | | | | |
| sample | liquid | | | | | |
| No. | No. | Aging | a) | b) | c) | d) |
| 1 (Inv.) | (1) | No | 20 | >300 | A | >10,000 |
| | | Yes | 30 | >300 | A | >10,000 |
| 2 (Inv.) | (2) | No | 15 | >300 | A | >10,000 |
| | | Yes | 20 | >300 | A | >10,000 |
| 3 (Comp.) | (3) | No | e) | g) | g) | 0 |
| | | Yes | f) | >300 | A | 0 |
| 4 (Comp.) | (4) | No | e) | g) | g) | 0 |
| | | Yes | f) | >300 | A | 0 |
| 5 (Comp.) | (5) | No | 20 | 75 | C | 4,000 |
| | | Yes | 40 | 50 | C | 5,000 |

Inv.: Inventive;
Comp.: Comparative
a): Initial printability (number);
b): Scratch stain resistance 1 (g);
c): Scratch stain resistance 2;
d): Printing durability;
e): Stain fault;
f) Ink-reception failure;
g): Indiscriminative

As is apparent from Table 2, inventive printing plate material samples provide excellent initial printability, excellent scratch stain resistance and high printing durability. Comparative printing plate material samples 3 and 4 each containing no carbonates, which have not been subjected to aging, cause stain occurrence at the entire surface of the printing paper, since water resistance of the image formation layer is low both at exposed portions and at unexposed portions and the entire image formation layer is removed during on-press development. While Comparative printing plate material samples 3 and 4, which have been subjected to aging, lower ink reception, since water resistance of the image formation layer increases but image formation layer at unexpected portions is difficult to remove.

### Example 2

(Preparation of Image Formation Layer Coating Liquids)

The following image formation layer coating liquid composition as shown in Table 3 was sufficiently mixed while stirring, and filtered to obtain an image formation layer coating liquid having a solid content of 5%. Thus, image formation layer coating liquid Nos. (6) through (9) were obtained.

TABLE 3
(Image formation layer coating liquid composition)

| | Image formation | | | |
|---|---|---|---|---|
| Materials for image formation | layer coating liquid Nos. | | | |
| layer coating liquid composition | (6) | (7) | (8) | (9) |
| Aqueous lithium silicate solution | *2 | | | |
| (produced by Nissan Kagaku Co., | 8.18 | 8.18 | 12.27 | 13.30 |
| Ltd., SiO₂ content: 20%, | | | | |
| SiO₂/Li₂O (by mole): 4.5) | | | | |
| Guanidine carbonate | 1.00 | 1.25 | None | None |
| Aqueous PMMA (high heat- | 15.00 | None | 15.00 | None |
| resistant) particle dispersion | | | | |
| (Eposter produced by Nippon | | | | |
| Shokubai Co., Ltd., average | | | | |
| particle size: 110 nm, heat | | | | |
| resistant temperature: not less | | | | |
| than 280° C., solid content: 10%) | | | | |
| Aqueous blocked isocyanate | None | 2.84 | None | 2.84 |
| dispersion (*1 WB-700 produced by | | | | |
| Mitsui Takeda Chemicals Co., | | | | |
| Ltd., dissociation temperature: | | | | |
| 120° C., solid content: 44%) | | | | |
| 1% Aqueous solution of light-to- | 50.00 | 50.00 | 50.00 | 50.00 |
| heat conversion material, water | | | | |
| soluble infrared absorbing dye | | | | |
| (IR-1) | | | | |
| Pure water | 25.82 | 37.73 | 22.73 | 33.86 |

*1: Trimethylol propane adduct of TDI (in which an oxime type blocking agent is used.)
*2: Numerical values are parts by weight.

(Preparation of Oleophilic Overcoat Layer Coating Liquid)

Film-forming acryl emulsion WSA-900 (manufactured by Dainippon Ink Co., Ltd.) and stearic acid amide emulsion L-271 (manufactured by Chukyo Yushi Co., Ltd.) were mixed so that the solid content of the film-forming acryl emulsion was 90% and the solid content of the stearic acid amide emulsion was 10%. The resulting mixture was diluted with pure water to give a solid content of 5%, and filtered. Thus, oleophilic overcoat layer coating liquid was obtained.

(Preparation of Printing Plate Material Samples)

The image formation layer coating liquid prepared in Example 1 or 2 above was coated on the surface of the substrate 1 above, as shown in Table 4, employing a wire bar, and dried at 55° C. for 3 minutes to form an image formation layer having a dry thickness of 0.8 g/m². Subsequently, the oleophilic overcoat layer coating liquid was coated on the resulting image formation layer as shown in Table 4, employing a wire bar, and dried at 55° C. for 3 minutes to form an oleophilic overcoat layer having a dry thickness of 0.3 g/m². After that, the resulting product was subjected to aging at 40° C. for 48 hours. Thus, negative working printing plate material samples 6 through 12 were obtained.

(Evaluation)

The negative working printing plate material samples 6 through 12 were imagewise exposed in the same manner as in Example 1, and evaluation thereof was made in the same manner as in Example 1.

The results are shown in Table 4.

TABLE 4

| | Image | | | | | |
|---|---|---|---|---|---|---|
| Printing | formation | | | | | |
| plate | layer | Oleophilic | | | | |
| material | coating | overcoat | | | | |
| sample No. | liquid No. | layer | a) | b) | c) | d) |
| 6 (Inv.) | (2) | Yes | 30 | >300 | A | 10,000 |
| 7 (Inv.) | (6) | No | 20 | 250 | A | >10,000 |
| 8 (Inv.) | (6) | Yes | 30 | >300 | A | >10,000 |
| 9 (Inv.) | (7) | No | 20 | 250 | A | >10,000 |
| 10 (Inv.) | (7) | Yes | 30 | >300 | A | >10,000 |
| 11 (Comp.) | (8) | No | e) | g) | g) | 0 |
| 12 (Comp.) | (9) | No | e) | g) | g) | 0 |

Inv.: Inventive,
Comp.: Comparative
a): Initial printability (number);
b): Scratch stain resistance 1 (g);
c): Scratch stain resistance 2;
d): Printing durability;
e): Stain fault;
g): Indiscriminative

As is apparent from Table 4, inventive printing plate material samples provide excellent initial printability, excellent scratch stain resistance and high printing durability. In Comparative printing plate material samples 11 and 12 each containing no carbonates, image formation layer containing oleophilic particles is difficult at unexpected portions to remove, resulting in stain occurrence.

1. A printing plate material comprising a substrate and provided thereon, a component layer and a thermosensitive image formation layer, the component layer being provided between the substrate and the thermosensitive image formation layer, wherein the thermosensitive image formation layer contains a silicate and a carbonate, and at least one of the component layer and the thermosensitive image formation layer contains a light-to-heat conversion material.

2. The printing plate material of claim 1, wherein the silicate is lithium silicate.

3. The printing plate material of claim 1, wherein the thermosensitive image formation layer further contains particles with an average particle size of from 50 nm to 5 μm.

4. The printing plate material of claim 3, wherein the particles are metal oxide particles or particles of a blocked isocyanate compound, which is a reaction product of an isocyanate compound, a polyol, and an isocyanate group-blocking agent.

5. The printing plate material of claim 1, wherein the thermosensitive image formation layer contains a light-to-heat conversion material.

6. The printing plate material of claim 1, wherein an oleophilic overcoat layer, containing heat curable resins or thermoplastic resins, is provided on the thermosensitive image formation layer.

7. The printing plate material of claim 1, wherein the component layer is a hydrophilic layer comprising metal oxide particles.

8. The printing plate material of claim 1, wherein the component layer is an oleophilic layer comprising an oleophilic organic polymer.

9. The printing plate material of claim 1, wherein the thermosensitive image formation layer contains 10 to 80% by weight in terms of SiO₂ of the silicate and 5 to 50% by weight of the carbonate.

10. A printing plate material comprising a substrate, the surface of which is subjected to hydrophilization treatment to form a hydrophilic surface, and a thermosensitive image formation layer on the hydrophilic surface, wherein the thermosensitive image formation layer contains a silicate, a carbonate, and a light-to-heat conversion material.

11. The printing plate material of claim 10, wherein the silicate is lithium silicate.

12. The printing plate material of claim 10, wherein the thermosensitive image formation layer further contains particles with an average particle size of from 50 nm to 5 μm.

13. The printing plate material of claim 12, wherein the particles are metal oxide particles or particles of a blocked isocyanate compound, which is a reaction product of an isocyanate compound, a polyol, and an isocyanate group-blocking agent.

14. The printing plate material of claim 10, wherein an oleophilic overcoat layer, containing heat curable resins or thermoplastic resins, is provided on the thermosensitive image formation layer.

15. The printing plate material of claim 10, wherein the thermosensitive image formation layer contains 10 to 80% by weight in terms of SiO₂ of the silicate and 5 to 50% by weight of the carbonate.

16. A process of manufacturing a printing plate, the process comprising the steps of:
imagewise exposing the printing plate material of claim 1 and
carrying out on-press development by supplying a dampening water to the exposed printing plate material on the plate cylinder of a press, whereby the image formation layer at unexposed portions is removed.

17. A process of manufacturing a printing plate, the process comprising the steps of:
imagewise exposing the printing plate material of claim 10; and
carrying out on-press development by supplying a dampening water to the exposed printing plate material on the plate cylinder of a press, whereby the image formation layer at unexposed portions is removed.
